(19) United States
(12) Patent Application Publication
(10) Pub. No.: US 2004/0204993 A1
(43) Pub. Date: Oct. 14, 2004

(54) Advertising method and system using printing apparatus

(75) Inventors: Sung-Won Chae, Gwangmyung-si (KR); Dae-Hyun Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-City (KR)

(21) Appl. No.: 10/625,571

(22) Filed: Jul. 24, 2003

(30) Foreign Application Priority Data
Sep. 19, 2002 (KR) 2002-57318

(51) Int. Cl. G06F 17/60

(52) U.S. Cl. 705/14

(57) ABSTRACT

An advertising system includes a layout setter providing layout information regarding document data and advertisement data to be printed on a paper. A document data processor creates print data for a document by converting the document data into a predetermined printing apparatus description language based on the layout information. An advertisement data processor creates print data for an advertisement by processing the advertisement data according to the layout information. A combining unit combines the print data for the document and the print data for the advertisement to create combined print data including the advertisement.

### CROSS-REFERENCE TO RELATED APPLICATIONS

This application claims the priority of Korean Patent Application No. 2002-57318 filed on Sep. 19, 2002, in Korean Intellectual Property Office, the disclosure of which is incorporated herein in its entirety by reference.

### BACKGROUND OF THE INVENTION

1. Field of the Invention

The present invention relates to an advertising method and system, and more particularly, to an advertising method and system using a printing apparatus that prints print data including an advertisement that is a combination of desired document data and a predetermined advertisement data.

2. Description of the Related Art

Mobile or office service providers have raced to provide service zones where mobile or office service users are allowed to use office equipment, such as a printer, a facsimile, and a photocopy machine, without cost. Further, the number of mobile or office service users who desire to use the service zones has steadily increased. Accordingly, the need of placing advertisements by the free service providers in outputs of such office equipment is growing.

### SUMMARY OF THE INVENTION

The present invention provides an advertising method that uses a printing apparatus that allows a user to print document data including advertisement data by converting document data and advertisement data into print data for a document and print data for an advertisement, respectively, based on layout information selected by the user, combining the two print data using, for example, an overlay method, and printing the combination result.

The present invention also provides an advertising system embodying the above-described advertising method of the present invention.

The present invention may be achieved by an advertising method using a printing apparatus comprising creating layout information regarding document data and advertisement data to be printed on paper; converting the document data into print data for a document, based on the created layout information and the printing apparatus setting information, the document data generated using a predetermined application program; creating print data for an advertisement by processing the advertisement data based on the created layout information; creating combined print data including the advertisement by combining the print data for the document and the print data for the advertisement; and printing the combined print data including the advertisement.

The present invention may be also realized as a computer readable recording medium that records a program executable by a computer. The program comprises a first program that creates layout information containing layouts of document data and advertisement data to be printed on paper, a scale-down ratio of a display size of the document data, and an extent of watermarking, a second program that converts the document data into print data for a document based on the layout information and printer setting information, the document data generated using a predetermined application program, a third program that creates print data for an advertisement by processing a predetermined advertisement data based on the layout information, and a fourth program that creates combined print data including the advertisement by combining the print data for the document and the print data for the advertisement.

The present invention may also be achieved by an advertising system using a printing apparatus comprising a layout setter that provides layout information regarding document data and advertisement data to be printed on paper; a document data processor that creates print data for a document by converting the document data into a predetermined printing apparatus description language based on the layout information provided by the layout setter, the document data generated using a predetermined application program; an advertisement data processor that creates print data for an advertisement by processing a predetermined advertisement data according to the layout information provided from the layout setter; and a combining unit that combines the print data for the document sent from the document data processor and the print data for the advertisement sent from the advertisement data processor to creates combined print data including the advertisement.

### BRIEF DESCRIPTION OF THE DRAWINGS

The above/or and other aspects and advantages of the present invention will become apparent and more readily appreciated from the following description of the embodiments taken in conjunction with the accompanying drawings in which:

FIG. 1 is a block diagram of an advertising system using a printing apparatus, according to an embodiment of the present invention;

FIG. 2 is a detailed block diagram of the host computer shown in FIG. 1;

FIGS. 3A through 3C are layout diagrams created by the layout setter of FIG. 2;

FIG. 4 is a flowchart of processing document data to include an advertisement using a printing apparatus, according to an embodiment of the present invention; and

FIG. 5 is a flowchart of processing advertisement data to be included in a document using a printing apparatus, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

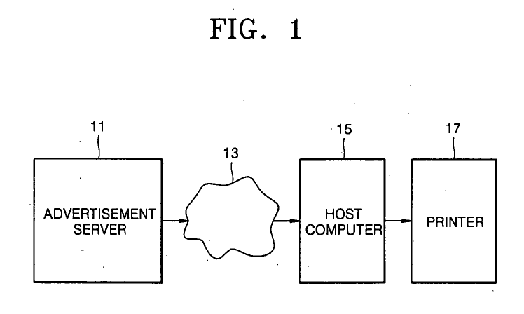

FIG. 1 is a block diagram of an advertising system, according to an embodiment of the present invention. The advertising system comprises an advertisement server 11, a host computer 15, and a printer 17. The advertisement server 11, the host computer 15, and the printer 17 are connected to one another via a network 13, such as Local Area Network (LAN) or the Internet.

Referring to FIG. 1, the advertisement server 11 provides advertisement data to the host computer 15 via the network 13. In detail, the advertisement server 11 receives a signal, which contains a request for the advertisement data, transmitted from the host computer 15 and provides the advertisement data to the host computer 15 based on, for example, user information detected from a user identifier contained in the signal. The host computer 15 combines print data for an advertisement, which is based upon the received advertisement data and print data for a document to produce combined print data including the advertisement. The printer 17 prints the combined print data including the advertisement, which is provided from the host computer 15, on paper.

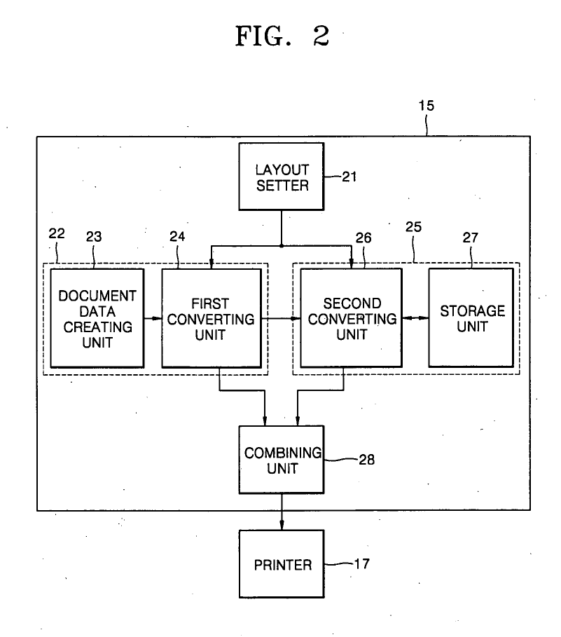

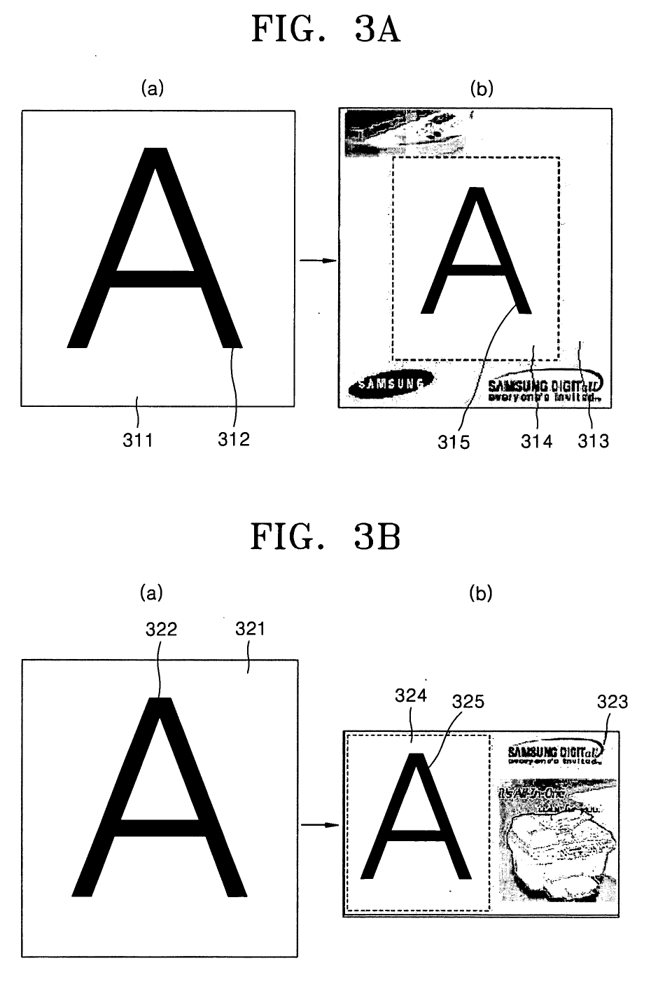

FIG. 2 is a detailed block diagram of the host computer 15 of FIG. 1, according to an embodiment of the present invention. The host computer 15 comprises a layout setter 21, a document data processor 22, an advertisement data processor 25, and a combining unit 28. The document data processor 22 comprises a document data creating unit 23, and a first converting unit 24, and the advertisement data processor 25 comprises a second converting unit 26 and a storage unit 27. Referring to FIG. 2, the layout setter 21 sets layouts of print data for a document and print data for an advertisement to be printed on paper. For example, a user may select one of first through third layouts shown in FIGS. 3A through 3C.

In the first layout shown in FIG. 3A, illustration (a) shows the original document in which document data 312 is illustrated in the entire area 311 of a paper, and illustration (b) shows a document including an advertisement in which advertisement data is illustrated in an advertisement area 313 of the paper along with document data 315 in a data area 314 The document data 315 is a reduced sized document data 312, which is illustrated in the data area 314. In other words, when the first layout is selected, the layout setter 21 determines the left, right, upper, and lower margins of the paper to set a range of the advertisement area 313 and also determines a scale-down ratio of the document data 312.

In the second layout of FIG. 3B, illustration (a) shows the original document in which document data 322 is illustrated in the entire area 321 of a paper, and illustration (b) shows the document including an advertisement in which document data 325 is illustrated in a first area 324 of the paper and advertisement data is illustrated in a second area 323 of the paper. The document data 315 is a reduced sized document data 322. When the second layout is selected, the layout setter 21 determines a division ratio of the paper, a position of the advertisement data in a divided area of the paper based upon the division ratio, and a scale-down ratio of the document data 322.

In the third layout of FIG. 3C, illustration (a) shows the original document in which print data 332 for a document is illustrated in the entire area 331 of a paper, and illustration (b) shows a document including an advertisement in which document data 335 and watermarked advertisement data 334 are illustrated in the entire area 333 of the paper. When the third layout is selected, the layout setter 21 additionally sets the intensity of watermark processing into the advertisement data.

In FIG. 2, in the document data processor 22, the document data creating unit 23 creates document data using an application program, such as a word processor. When a print command is rendered with respect to the document data created by the document data creating unit 23, the first converting unit 24 sends a signal requesting advertisement data to the second converting unit 26 of the advertisement data processor 25. Next, when a user selects parameters regarding the size of paper, a printing direction, and so on, and the user selects one of the first through third layouts set by the layout setter 21, the first converting unit 24 creates print data for a document by converting the document data into print data, for example, the Hewlett-Packard Printer Control Language (PCL) or the Adobe postscript page description language, using the selected parameters and according to the selected layout.

In FIG. 2, in the advertisement data processor 25, various types of advertisement data is stored in the storage unit 27. When the first converting unit 24 sends a signal containing a request for advertisement data to the second converting unit 26, the second converting unit 26 converts advertisement data, which is selected and read from the storage unit 27, into print data for an advertisement using the selected parameters and according to the selected layout of the first through third layouts set by the layout setter 21. According to an aspect of the invention, the second converting unit 26 can request the advertisement server 11 to provide the advertisement data, via the network 13, and store the advertisement data provided from the advertisement server 11 in the storage unit 27. Further, the second converting unit 26 may store in the storage unit 27 advertisement data, which is transmitted from the advertisement server 11 irrespective of whether the second converting unit 26 makes a request to receive the advertisement data. Further, the second converting unit 26 may store generated advertisement data using an application program, such as PHOTOSHOP.

In FIG. 2, the combining unit 28 combines the print data for a document sent from the first converting unit 24 and the print data for an advertisement sent from the second converting unit 26 using, for example, an overlay method to produce combined print data including the advertisement as shown in illustration (b) of FIGS. 3A, 3B, or 3C, and transmits the combined print data including the advertisement to the printer 17.

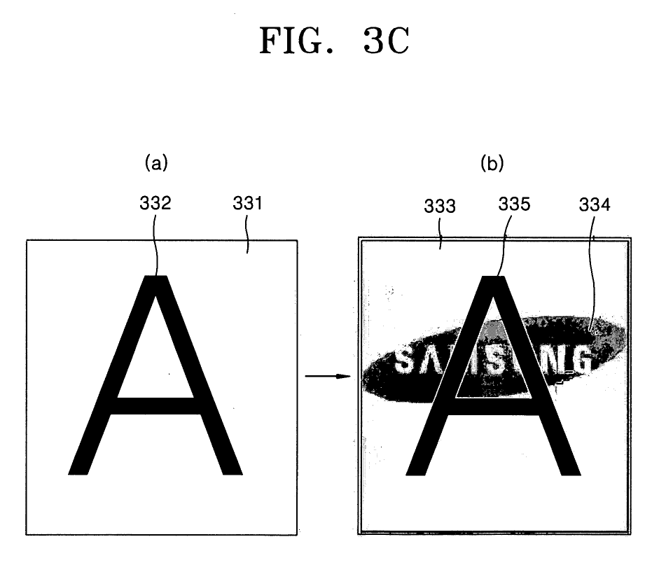

FIG. 4 is a flowchart of processing document data to include an advertisement using a printing apparatus, according to an embodiment of the present invention. Referring to FIG. 4, at operation 41, the document data creating unit 23 creates document data using an application program, such as a word processor. In operation 42, the first converting unit 24 receives a print command with respect to the documents data created in operation 41. In operation 43, the first converting unit 24 requests the second converting unit 26 of the advertisement data processor 25 to provide advertisement data. In operation 44, the first converting unit 24 receives layout information that contains information regarding a layout set by the layout setter 21 (e.g., the advertisement print layouts as shown in illustration (b) of FIGS. 3A, 3B, or 3C FIGS. 3) and various printing related parameters. In operation 45, the document data is converted into print data for a document, based on the printing related information, such as paper size, a printing direction, and so on, and the layout information received in operation 44.

FIG. 5 is a flowchart of processing advertisement data to be included in a document using a printing apparatus, according to an embodiment of the present invention. Referring to FIG. 5, the second converting unit 26 receives a signal containing a request for advertisement data from the first converting unit 24 in operation 51 (i.e., the signal from the first converting unit 24 in FIG. 4 operation 43). In operation 52, the first converting unit 24 receives a layout information set by the layout setter 21 (e.g., the advertisement print layouts as shown in illustration (b) of FIGS. 3A, 3B, or 3C FIGS. 3) and layout information contained in various printing related parameters. In operation 53, the advertisement data is converted into print data for an advertisement, based on the layout information received in operation 52.

The present invention can be embodied as a computer readable code stored in a computer readable medium and controlling a computing device, such as the host computer 15, a printer, a server, etc., according to the above-described processes of the invention. Here, the computer readable medium may be any recording apparatus capable of storing data that can be read by a computer system, e.g., read-only memory (ROM), random access memory (RAM), compact disc (CD)-ROM, a magnetic tape, a floppy disk, an optical data storage device, and so on. Also, the computer readable medium may be a carrier wave that transmits data via the Internet, for example. Further, using an overlay method to combine the print data of a document and an advertisement is according to known techniques, and the other known methods may be used to combine the print data and achieve the present invention.

As described above, according to the present invention, to print document data created by an application program, document data and advertisement data are converted into print data for a document and print data for an advertisement, respectively, based on layout information selected by a user. Next, the print data for the document and the print data for the advertisement are combined using, for example, an overlay method and the combined print data is printed using a printer. Accordingly, the printer can be used as an advertising medium, and therefore, it is possible to enhance advertisement effect for products at a low cost even if free printing services are provided to users. Accordingly, the present invention provides a business method of advertising by providing office (i.e., office type) or customer printing services using a printing device, generating a combined print data of a document and an advertisement in response to a request to print the document by the printing device, and printing the combined data by printing device. According to an aspect of the invention selectable print layouts are provided and the document and advertisement print data are combined according to the selected print layout. More particularly, the present invention providing advertising by printing a combined print data of a document and an advertisement in response to a request to print the document.

While this invention has been particularly shown and described with reference to a few embodiments thereof, it will be understood by those skilled in the art that various changes in form and details may be made therein without departing from the spirit and scope of the invention as defined by the appended claims and their equivalents.

What is claimed is:

1. An advertising system using a printing apparatus comprising:
a layout setter providing layout information regarding document data and advertisement data to be printed on a paper;
a document data processor that creates print data for a document by converting the document data into a predetermined printing apparatus description language based on the layout information provided by the layout setter, the document data generated using a predetermined application program;
an advertisement data processor creating print data for an advertisement by processing a predetermined advertisement data according to the layout information provided from the layout setter; and
a combining unit combining the print data for the document sent from the document data processor and the print data for the advertisement sent from the advertisement data processor to create combined print data including the advertisement.

2. The system of claim 1, further comprising an advertisement server connected to the advertisement data processor via a network and providing the predetermined advertisement data to the advertisement data processor.

3. The system of claim 1, wherein the layout setter sets one of first through third layouts, the first layout in which the advertisement data is illustrated in an advertisement area of the paper, the second layout in which the advertisement data is illustrated in a divided area of the paper, and the third layout in which the advertisement data is illustrated in the entire area of the paper.

4. The system of claim 2, wherein the layout setter sets one of first through third layouts, the first layout in which the advertisement data is illustrated in an advertisement area of the paper, the second layout in which the advertisement data is illustrated in a divided area of the paper, and the third layout in which the advertisement data is illustrated in the entire area of the paper.

5. The system of claim 3, wherein the document data processor scales down a size of the document data according to a predetermined ratio when the first or second layout is selected.

6. The system of claim 3, wherein the advertisement data processor performs watermark processing for the advertisement data when the third layout is selected.

7. The system of claim 4, wherein the document data processor scales down the document data according to a predetermined ratio when the first or second layout is selected.

8. The system of claim 4, wherein the advertisement data processor performs watermark processing for the advertisement data when the third layout is selected.

9. The system of claim 2, wherein the advertisement server provides the advertisement data to the advertisement data processor, based on user information.

10. An advertising method using a printing apparatus comprising:
creating layout information regarding document data and advertisement data to be printed on paper;
converting the document data into print data for a document, based on the created layout information and printing apparatus setting information, the document data generated using a predetermined application program;
creating print data for an advertisement by processing a predetermined advertisement data based on the created layout information;
creating combined print data including the advertisement by combining the print data for the document and the print data for the advertisement; and
printing the combined print data including the advertisement.

11. The method of claim 10, wherein the layout information contains at least one of a desired layout, a scale-down ratio of a display size for the document data, and an intensity information of watermark processing.

12. The method of claim 10, wherein the predetermined advertisement data is provided from an advertisement server connected to a network.

13. A computer readable recording medium storing programs executable by a computer, wherein the programs comprise:
a first program creating layout information containing layouts of document data and advertisement data to be printed on a paper, a scale-down ratio of a display size of the document data, and watermarking intensity information;
a second program converting the document data into print data for a document based on the layout information and printer setting information, the document data generated using a predetermined application program;
a third program creating print data for an advertisement by processing a predetermined advertisement data based on the layout information; and
a fourth program creating combined print data including the advertisement by combining the print data for the document and the print data for the advertisement.

14. A machine readable storage storing at least one program controlling a computer according to a process comprising:
providing selectable layout information regarding document data and advertisement data to be printed on paper, converting the document data into print data based upon the selected layout information upon printing the document data, creating print data for a predetermined advertisement based upon the selected layout information, creating combined print data including the advertisement by combining the print data for the document data and the print data for the advertisement, and printing the combined print data including the advertisement.

15. The storage of claim 14, wherein the selectable layout information comprise one of first through third layouts, the first layout in which the advertisement is printed in an advertisement area on a paper, the second layout in which the advertisement is printed in a divided area of the paper, and the third layout in which the advertisement is printed in the entire area of the paper.

16. An advertising method, comprising:
printing a combined print data of a document and an advertisement in response to a request to print the document.

17. An advertising method, comprising:
providing office type printing services using a printing device;
generating a combined print data of a document and an advertisement in response to a request to print the document by the printing device; and
printing the combined data by printing device.

18. The method of claim 17, further comprising:
providing selectable print layouts and combining the document and advertisement print data according to the print layout.

19. The method of claim 17, wherein the advertisements are according to a user information.

20. A printer, comprising:
a programmed processor providing selectable layout information regarding document data and advertisement data to be printed on paper, converting the document data into print data based upon the selected layout information upon printing the document data, creating print data for a predetermined advertisement based upon the selected layout information, creating combined print data including the advertisement by combining the print data for the document data and the print data for the advertisement, and printing the combined print data including the advertisement.
